(19) United States
(12) Patent Application Publication
(10) Pub. No.: US 2016/0184781 A1
(43) Pub. Date: Jun. 30, 2016

(54) DEVICE FOR AERATING WINE

(71) Applicants: Andrew Richard Thomas Tatarek, Aldershot (GB); Thomas Bickford Holbeche, Church Crookham (GB)

(72) Inventors: Andrew Richard Thomas Tatarek, Aldershot (GB); Thomas Bickford Holbeche, Church Crookham (GB)

(21) Appl. No.: 15/062,234

(22) Filed: Mar. 7, 2016

Related U.S. Application Data
(63) Continuation-in-part of application No. 14/972,758, filed on Dec. 17, 2015.

(30) Foreign Application Priority Data
Dec. 23, 2014 (EP) 14 004 380.3
Dec. 18, 2015 (EP) 15 003 620.0

(51) Int. Cl. B01F 3/04

(52) U.S. Cl. CPC B01F 3/04794

(57) ABSTRACT

Wine aerating device having a container containing pressurized gas, a body member and a lance member for inserting into wine to be aerated, the container, the body member and the lance member being engageable to provide a passage for passing pressurized gas in a downstream direction from the container through the body member into the lance member, the lance member being engageable with the body member by means of insertion into the body member, the body member being provided with a valve, the valve being arranged such that in case the lance member is disengaged from the body member, it defines a closed position preventing flow of gas through the body member, and in case the lance member engages the body member, it is pushed into an open position, the open position allowing flow of gas through the body member into the lance member.

The present invention relates to a device for aerating or oxygenating wine.

Adding controlled amounts of oxygen to wine, or aerating the wine, is known to improve its taste. Typically, wine is aerated before use via a decanter or carafe. In a recent development wine can also be aerated using a venturi type system whereby the wine is poured from the bottle into an intermediary vessel above the wine glass, and the wine then aerated via the venturi effect as it passes from the intermediary vessel to the wine glass. Both of these aerating methods however are limited in terms of the rate of which air can be introduced into the wine.

Wine aerating devices comprising a container for pressurized oxygen containing gas, such as air, a body member for holding the gas container, and a lance member, via which gas from the gas container can be diffused into a wine, are known.

The invention attempts to simplify the design of a wine aerating device.

The wine aerating device according to the invention comprises a container containing pressurized gas, a body member and a lance member for inserting into wine to be aerated, the container, the body member and the lance member being engageable in such a way as to provide a passage for passing pressurized gas in a downstream direction from the container through the body member into the lance member, the lance member being engageable with the body member by means of insertion into the body member, the body member being provided with a valve, arranged such that in case the lance member is disengaged from the body member the valve defines a closed position preventing flow of gas through the body member, and in case the lance member engages the body member, to be pushed into an open position, the open position allowing flow of gas through the body member into the lance member, wherein there is provided a bayonet closure for engagement of the lance member with the body member. Such a bayonet closure provides a simple and robust engagement for the lance member with respect to the body member.

The arrangement of the valve according to the present invention provides a tight seal, preventing unwanted escape of gas from the body member in case no lance member is engaged with the body member. It also allows flow of gas through the body member and the lance in case of engagement of a lance with the body member, at the same time preventing gas escaping through any other paths within the body member.

The term “downstream direction” as used in this specification refers to the airflow of gas from the gas container (cylinder) through the body member to the lance. The “upstream direction” is the opposite direction. Thus, the body member is arranged downstream of the gas container, and the lance downstream of the body member. The terms “air” and “gas” are used synonymously throughout the specification.

The valve is arranged to be pushed from the closed position into the open position by the upstream end of the lance being inserted into a bore provided in the body member from the downstream end of the body member. This provides a simple and robust engagement and disengagement of the lance with respect to the body member, at the same time ensuring a tight seal in the closed as well as the opened position.

At least one annular seal is provided in the passage within the body member, which is arranged for engagement with the valve in the closed position, and with the lance member in the open position. By appropriate design of such an annular seal, it can be ensured that in the closed position the annular seal tightly surrounds the valve, thus blocking the passage and preventing any escape of gas from the body member. Also, in the open position, the annular seal can form a tight seal with the lance member, ensuring that escape of gas will only occur through a central passage within the lance member.

The valve is provided as a spring biased valve comprising a valve body and a spring engaging the valve body. By means of such a spring biased valve, it can be easily ensured that, in case of disengagement of a lance with respect to the body member, i.e. no lance being connected to the member, the valve housing is urged into the closed position by means of the spring.

The container, especially a cylinder, the tube, and the lance may be co-axial to provide an easily determinable centre of gravity tor the device. This axis may extend through the neck of the wine bottle when the device is placed thereon. With this arrangement, when the device is placed on the bottle, the device's centre of gravity is more likely to act through the neck of the wine, ensuring that the device is stable on the bottle.

It will also be appreciated that any form of pressurized gas source may be used. Indeed, the gas container described above may be single use, replaceable or refillable. The device may be manufactured and distributed with or without a pressurized gas container.

It should be noted that the previously mentioned features and the features to be further described in the following are usable not only in the respectively indicated combination, but also in further combinations or taken alone, without departing from the scope of the present invention.

The present invention will now be further described with reference to the following figures in which:

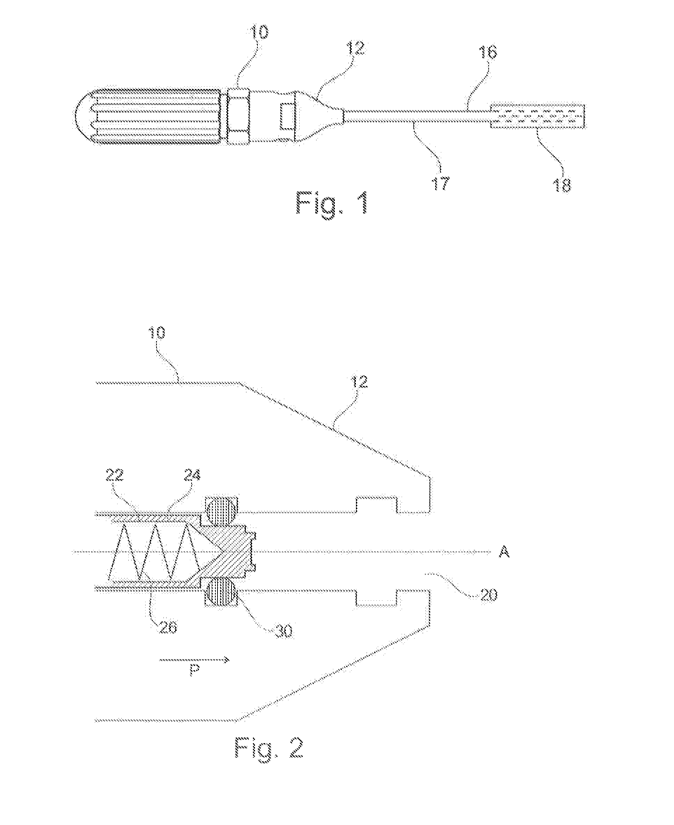

FIG. 1 shows a plan view of wine aerating device according to an embodiment of an invention;

FIG. 2 shows a partial sectional view of an embodiment of a aerated wine aerating device according to the invention in a first mode of operation;

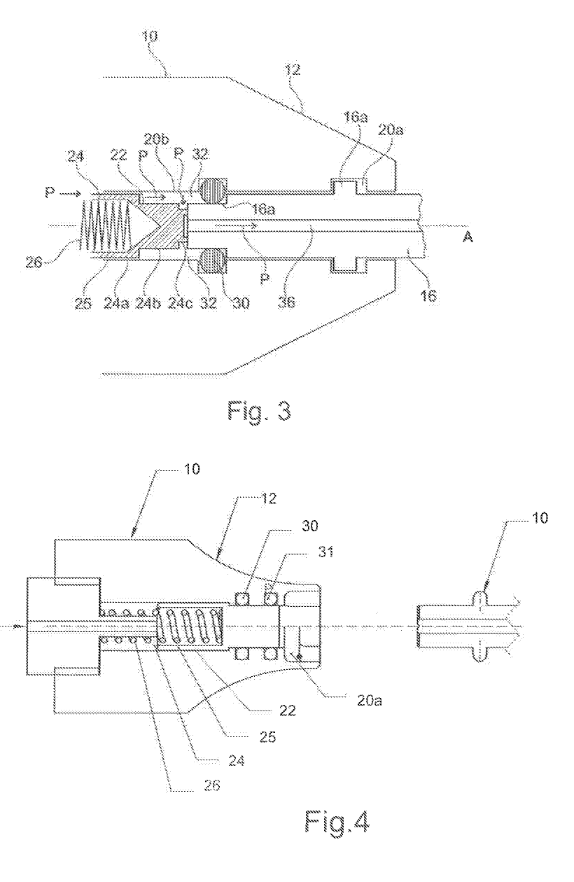

FIG. 3 shows a corresponding view of the wine aerating device according to FIG. 2 in a second mode of operation;

FIG. 4 shows a partial sectional view of wine aerating device according to another embodiment of the invention wherein the lance member is disengaged from the body member; and

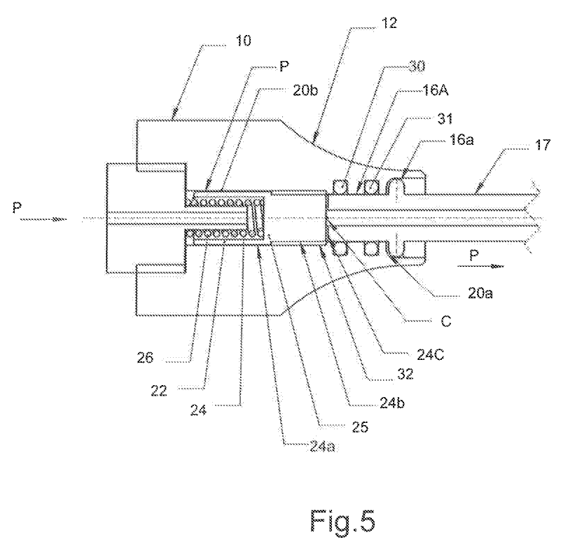

FIG. 5 shows a corresponding view of the wine aerating device shown in FIG. 4 wherein the lance member engages the body member.

The aerating device comprises a body member 10 for holding a gas container (cylinder) (not shown) and a lance member 16 comprising a tube 17 and a diffusor body 18. The diffusor body 18 is arranged downstream of the tube 17, the tube 17 downstream of body member 10. In use, the aerating device is arranged to engage with the neck of a wine bottle, which has e. g. a fluid content of 75 cl, not shown, via an interface 12. The interface also connects the body member 10 to the tube 17 of lance member 16. The interface 12 forms a conical shape, which is dimensioned to fit inside or on the neck of a wine bottle.

FIGS. 2 and 3 show a sectional view through interface 12, i.e. the section of the body member 10, where tube 17 of lance member 16 engages the body member 10. For ease of reference, the following description will refer only to lance member 16.

The body member 10 is provided with a cylindrical bore 20 extending along its central axis A which is provided in a stepped manner in order to hold various components, as will be further explained in the following. Also, the cylindrical bore forms part of a passage between a gas container (not shown) and the lance 16, for passing pressurized gas form the gas cylinder through the body member to the lance member 16.

In bore 20, there is provided a valve member 22. Valve member 22 comprises a valve body 24 and a spring element 26. The valve body comprises a first portion 24a with a first diameter, which essentially corresponds to the diameter of the bore 20. It comprises a second portion 24b with a second diameter, which is smaller than the first diameter and a third portion 24c, with a third diameter, which can either be smaller or the same size as the second diameter.

In the closed position shown in FIG. 2, the spring element 26 biases the valve housing 24 to the right, i.e. towards the downstream side of body element 10 as symbolised by arrow P, so that the second section 24b of valve body engages an O-ring acting as an annular seal, preventing any gas upstream of valve element 22 from escaping through the downstream side of housing member 10, i.e. the downstream end of bore 20. In this mode of operation, the spring 26 is in an expanded state.

In FIG. 3, a lance member 16 is inserted through the downstream opening of bore 20. As can be seen in FIG. 3, the upstream end of lance member 16 has pushed the valve body 24 out of engagement with O-ring 30 by compressing spring 26, at the same time providing an engagement between an upstream end section 16a of the lance 16 with the O-ring 30.

In this position, valve body 24 has been pushed to the left, i.e. in the upstream direction of bore 20, and spring 26 is in a compressed state. The thus provided axial position of lance member 16 can be secured by turning lance member 16 by about 90° about central axis A, thus providing a bayonet closure between radial extensions 16b of the lance member 16 and a corresponding recess 20a in housing member 10, recess 20a forming radial extension of bore 20. In this position of lance 16, the spring is secured in its compressed state.

The diameter of the end portion 16a of lance member 16 expediently corresponds to the diameter of the second portion 24b of the valve body member.

In this position, a gas flow from the upstream side of valve element 22 to the downstream side of valve element 22 into a passage 36 within of lance 16 (represented by arrow p) can be achieved by providing axially extending openings in the circumferential wall 25 of valve body 24 (not shown in FIG. 3). By means of such openings pressurized air can enter into a space 32 between the second portion 24b of the valve body 24 and a wall 20b of bore 20, from where it can pass into the central passage 36 of lance 16 by means of radially extending openings, provided in third position 24c of valve body 24 (also not shown).

At the same time, the seal provided by the engagement of lance 16 and O-ring 30 ensures that no gas can escape through any other passage, for example any gaps between the outer circumference of lance member 16 and bore 20. By means of a (not shown) actuating mechanism, provided for example between the gas container and the body element 10, it can be ensured that gas can not escape from the gas container, even if lance member 16 engages body member 10 in the way shown in FIG. 3.

After usage, the state as shown in FIG. 2 can be re-established by disengaging lance 16 by a corresponding reverse 90° turn of the lance 16 and pulling it out of bore 20. Thus, valve housing 24 is urged back into its original position, as shown in FIG. 2, by spring 26.

A further embodiment of the invention is shown in FIGS. 4 and 5, where like reference numbers from FIGS. 1-3 are used for like components. In the embodiment depicted in FIGS. 4 and 5 a further O-ring 31 and a gas channel C are employed. Moreover, the lance member 16 has a diameter at the end part that is the same diameter as other parts. This differs from the embodiment of FIGS. 1 to 3 where because of the size of O-ring 30 the diameter of the end part of the lance 16 must be smaller than the other parts. According to the embodiment of FIGS. 4 and 5, the sealing of lance 16 can be carried our prior to moving the valve, thereby providing no chance for gas escape. The valve is also easier to manufacture as there is no need for the additional manufacturing step for machining the groove into the face of the valve. By use of the additional O-ring 31, sealing is more effective and the gas channel C can be configured as a gas channel slot which releases the gas from the gas container (not shown) through body member 10 into lance member 16.

The valve housing 24 is expediently made of stainless steel or brass. The lance 16 is preferably made of stainless steel.

1. Wine aerating device comprising a container containing pressurized gas, a body member and a lance member for inserting into wine to be aerated, the container, the body member and the lance member being engageable in such a way as to provide a passage for passing pressurized gas in a downstream direction from the container through the body member into the lance member, the lance member being engageable with the body member by means of insertion into the body member, the body member being provided with a valve, the valve being arranged such that in case the lance member is disengaged from the body member, it defines a closed position preventing flow of gas through the body member, and in case the lance member engages the body member, it is pushed into an open position, the open position allowing flow of gas through the body member into the lance member, wherein a bayonet closure is provided for engagement of the lance member with the body member.

2. Wine aerating device according to claim 1, wherein the valve is arranged to be pushed from the closed position into the open position by an upstream end of the lance member being inserted into a bore provided in the body member from the downstream end of the body member.

3. Wine aerating device according to claim 2, wherein at least one annular seal is provided in the bore, for engagement with the valve in the closed position, and with the lance member in the open position.

4. Wine aerating device according to claim 1, wherein the valve is provided as a spring biased valve.
